(19) United States
(12) Patent Application Publication
(10) Pub. No.: US 2025/0038469 A1
(43) Pub. Date: Jan. 30, 2025

(54) DISCHARGE ELECTRODES, MANUFACTURING METHOD OF ANODE, AND ELECTRONIC DEVICE MANUFACTURING METHOD

(71) Applicant: Gigaphoton Inc., Tochigi (JP)

(72) Inventors: Tsukasa HORI, Oyama-shi (JP); Masahide KATO, Oyama-shi (JP)

(73) Assignee: Gigaphoton Inc., Tochigi (JP)

(21) Appl. No.: 18/912,020

(22) Filed: Oct. 10, 2024

Related U.S. Application Data
(63) Continuation of application No. PCT/JP2022/019914, filed on May 11, 2022.

(51) Int. Cl. H01S 3/038; H01S 3/03

(52) U.S. Cl. CPC H01S 3/0381; H01S 3/0305; H01S 3/0382

(57) ABSTRACT

Discharge electrodes to be used in a gas laser device for exciting a laser gas containing fluorine by discharge include a cathode and an anode. The anode is arranged as facing the cathode and includes an electrode base member including a metal, and a coating layer including an insulating material and coating a part of a side surface, parallel to a longitudinal direction, of the electrode base member. The coating layer includes a first portion coating a first region of the side surface and a second portion coating a second region of the side surface, located farther from the cathode than the first region in a discharge direction perpendicular to the longitudinal direction, and being thicker than the first portion.

### CROSS-REFERENCE TO RELATED APPLICATIONS

The present application claims the benefit of International Application No. PCT/JP2022/019914, filed on May 11, 2022, the entire contents of which are hereby incorporated by reference.

### BACKGROUND

### 1. Technical Field

The present disclosure relates to discharge electrodes, a manufacturing method of an anode, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: Japanese Patent Application Publication No. 2004-179599

### SUMMARY

Discharge electrodes according to an aspect of the present disclosure are used in a gas laser device for exciting a laser gas containing fluorine by discharge and include a cathode and an anode. The anode is arranged as facing the cathode and includes an electrode base member including a metal, and a coating layer including an insulating material and coating a part of a side surface, parallel to a longitudinal direction, of the electrode base member. The coating layer includes a first portion coating a first region of the side surface and a second portion coating a second region of the side surface, located farther from the cathode than the first region in a discharge direction perpendicular to the longitudinal direction, and being thicker than the first portion.

A manufacturing method of an anode according to an aspect of the present disclosure is a manufacturing method of the anode of discharge electrodes to be used in a gas laser device for exciting a laser gas containing fluorine by discharge in arrangement as facing a cathode. The manufacturing method includes a first process of forming a coating layer on a side surface, parallel to a longitudinal direction, of an electrode base member configuring the anode, and a second process of removing a part of the coating layer to provide a shape close to a target shape. The second process includes removing a part of the coating layer such that a second portion coating a second region of the side surface, located farther from the cathode than a first region of the side surface in a discharge direction perpendicular to the longitudinal direction, is thicker than a first portion coating the first region.

An electronic device manufacturing method according to an aspect of the present disclosure includes generating laser light using a gas laser device including a laser chamber including discharge electrodes, outputting the laser light to an exposure apparatus, and exposing a photosensitive substrate to the laser light in the exposure apparatus to manufacture an electronic device. The discharge electrodes are to be used in the gas laser device for exciting a laser gas containing fluorine by discharge, and include a cathode and an anode. The anode is arranged as facing the cathode and includes an electrode base member including a metal, and a coating layer including an insulating material and coating a part of a side surface, parallel to a longitudinal direction, of the electrode base member. The coating layer includes a first portion coating a first region of the side surface and a second portion coating a second region of the side surface, located farther from the cathode than the first region in a discharge direction perpendicular to the longitudinal direction, and being thicker than the first portion.

### BRIEF DESCRIPTION OF THE DRAWINGS

Embodiments of the present disclosure will be described below merely as examples with reference to the accompanying drawings.

FIG. 1 schematically shows the configuration of a gas laser device according to a comparative example.

FIG. 2 schematically shows the configuration of a laser chamber shown in FIG. 1 and the inside thereof.

FIG. 3 is a perspective view of a cathode and an anode shown in FIGS. 1 and 2.

FIG. 4 is a sectional view of the anode used over a long period of time.

FIG. 5 schematically shows a state of discharge between the cathode and the anode in the comparative example.

FIG. 6 schematically shows a state after discharge between the cathode and the anode shown in FIG. 5 is performed.

FIG. 7 schematically shows a state of discharge subsequent to the discharge between the cathode and the anode shown in FIG. 5.

FIG. 8 schematically shows a state of discharge subsequent to the discharge between the cathode and the anode shown in FIG. 5.

FIG. 9 shows a side surface of the anode with a thickness of a portion of a coating layer coating the side surface reduced.

FIG. 10 is a sectional view of the anode configuring a discharge electrode according to a first embodiment.

FIG. 11 is a sectional view of the anode configuring the discharge electrode according to a second embodiment.

FIG. 12 is a sectional view showing a manufacturing process of the anode configuring the discharge electrode according to a third embodiment.

FIG. 13 is a sectional view showing a manufacturing process of the anode configuring the discharge electrode according to the third embodiment.

FIG. 14 is a sectional view showing a manufacturing process of the anode configuring the discharge electrode according to a fourth embodiment.

FIG. 15 is a sectional view showing a manufacturing process of the anode configuring the discharge electrode according to the fourth embodiment.

FIG. 16 schematically shows the configuration of an exposure apparatus connected to a gas laser device.

### DESCRIPTION OF EMBODIMENTS

### <Contents>

1. Comparative example
1.1 Configuration of gas laser device 1
1.2 Operation
1.3 Problem of comparative example
   2. Anode 11b having step at coating layer 112
2.1 Configuration
2.2 Effect
   3. Anode 11b having step at electrode base member 111
3.1 Configuration
3.2 Effect
   4. Manufacturing method of anode 11b having step at coating layer 112
4.1 Manufacturing process
4.2 Effect
   5. Manufacturing method of anode 11b having step at electrode base member 111
5.1 Manufacturing process
5.2 Effect

### 6. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Comparative Example

### 1.1 Configuration of Gas Laser Device 1

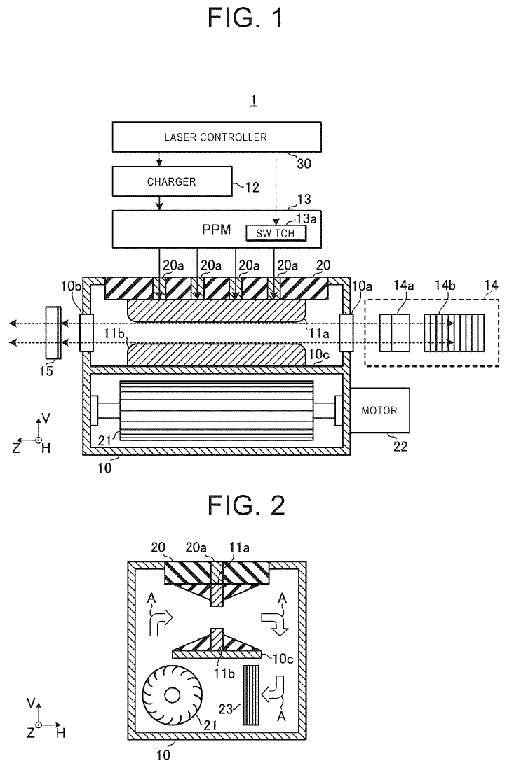

FIG. 1 schematically shows the configuration of a gas laser device 1 according to a comparative example. The gas laser device 1 shown in FIG. 1 includes a laser chamber 10, a cathode 11a and an anode 11b configuring a pair of discharge electrodes, a charger 12, a pulse power module (PPM) 13, a line narrowing module 14, an output coupling mirror 15, and a laser controller 30. The line narrowing module 14 and the output coupling mirror 15 configure an optical resonator. The laser chamber 10 is arranged on the optical path of the optical resonator. FIG. 1 shows the internal configuration of the laser chamber 10 viewed from a direction substantially perpendicular to the discharge direction between the cathode 11a and the anode 11b and substantially perpendicular to the travel direction of laser light output from the output coupling mirror 15.

FIG. 2 schematically shows the configuration of the laser chamber 10 shown in FIG. 1 and the inside thereof. FIG. 2 shows the internal configuration of the laser chamber 10 viewed from a direction substantially parallel to the travel direction of the laser light output from the output coupling mirror 15.

The travel direction of the laser light output from the output coupling mirror 15 is represented by the +Z direction. The discharge direction between the cathode 11a and the anode 11b is represented by the +V direction or the −V direction. The +Z direction and the +V direction are perpendicular to each other. A direction perpendicular to the both is represented by the +H direction or the −H direction. The −V direction substantially coincides with the gravity direction.

The laser chamber 10 accommodates the cathode 11a, the anode 11b, a cross flow fan 21, and a heat exchanger 23.

An opening is formed in a part of the laser chamber 10, which is closed by an electrically insulating portion 20. The electrically insulating portion 20 supports the cathode 11a. A plurality of conductive portions 20a are embedded in the electrically insulating portion 20. Each of the conductive portions 20a is electrically connected to the cathode 11a.

A return plate 10c is arranged in the laser chamber 10. The anode 11b is supported by the return plate 10c. The anode 11b is electrically connected to the ground potential via the return plate 10c and a conductive member of the laser chamber 10.

As shown in FIG. 2, the return plate 10c defines a gap through which the laser gas passes on each of the front and back sides of the paper surface of FIG. 1.

A rotation axis of the cross flow fan 21 is connected to a motor 22 arranged outside the laser chamber 10. The motor 22 rotates the cross flow fan 21. Thus, the laser gas circulates in the laser chamber 10 as indicated by arrow A in FIG. 2. The heat exchanger 23 exhausts the thermal energy of the laser gas, which has reached a high temperature due to the discharge, to the outside of the laser chamber 10.

The laser chamber 10 is filled with a laser gas containing, for example, an argon gas or a krypton gas as a rare gas, a fluorine gas as a halogen gas, a neon gas as a buffer gas, and the like. Alternatively, a laser gas containing a fluorine gas and a buffer gas may be enclosed. Windows 10a, 10b are provided at both ends of the laser chamber 10.

The charger 12 holds electric energy to be supplied to the pulse power module 13. The pulse power module 13 includes a charging capacitor (not shown) and a switch 13a. The charging capacitor of the pulse power module 13 is connected to the charger 12. The cathode 11a is connected to the charging capacitor of the pulse power module 13 via the conductive portion 20a.

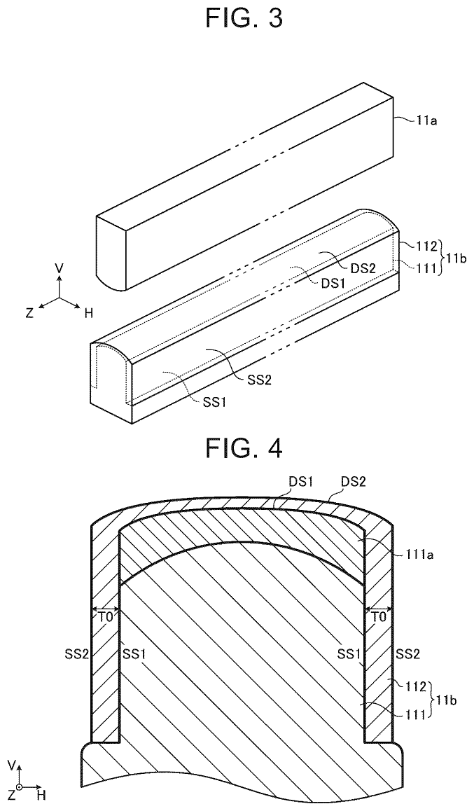

FIG. 3 is a perspective view of the cathode 11a and the anode 11b shown in FIGS. 1 and 2. Each of the cathode 11a and the anode 11b is substantially parallel to the Z axis. The anode 11b is arranged as facing the cathode 11a at a position in the −V direction viewing from the cathode 11a. In FIG. 3, vicinities of both ends of each of the cathode 11a and the anode 11b in the longitudinal direction are shown, and a part of the center is omitted.

The anode 11b includes a metal-containing electrode base member 111, and a coating layer 112 coating a part of the surface of the electrode base member 111 and containing an insulating material. The coating layer 112 is, for example, a thermal sprayed film of copper and alumina. A side surface SS1 of the electrode base member 111 and a side surface SS2 of the coating layer 112 are parallel to both the longitudinal direction of the electrode base member 111 and the discharge direction. A discharge surface of the electrode base member 111 facing the cathode 11a is referred to as a first discharge surface DS1. A discharge surface of the coating layer 112 facing the cathode 11a is referred to as a second discharge surface DS2.

In the present disclosure, the discharge surface refers to a surface that faces another electrode being a counterpart as a discharge electrode. When the first discharge surface DS1 is coated with the coating layer 112, discharge does not necessarily occur at the first discharge surface DS1.

Referring back to FIG. 1, the line narrowing module 14 includes a prism 14a and a grating 14b. Instead of the line narrowing module 14, a high reflection mirror may be used.

The output coupling mirror 15 is made of a material that transmits light having a wavelength selected by the line narrowing module 14, and one surface thereof is coated with a partially reflective film.

### 1.2 Operation

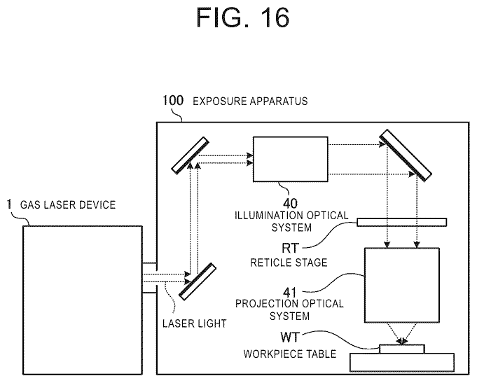

The laser controller 30 receives setting data of a target pulse energy and a light emission trigger signal from an exposure apparatus 100 (see FIG. 16). The laser controller 30 transmits setting data of the charge voltage to the charger 12 based on the setting data of the target pulse energy. Further, the laser controller 30 transmits a trigger signal to the pulse power module 13 based on the light emission trigger signal.

Upon receiving the trigger signal from the laser controller 30, the pulse power module 13 generates a pulse high voltage from the electric energy charged in the charger 12 and applies the high voltage between the cathode 11a and the anode 11b.

When the high voltage is applied between the cathode 11a and the anode 11b, discharge occurs between the cathode 11a and the anode 11b. The laser medium in the laser chamber 10 is excited by the energy of the discharge and shifts to a high energy level. When the excited laser medium then shifts to a low energy level, light having a wavelength corresponding to the difference between the energy levels is emitted.

The light generated in the laser chamber 10 is output to the outside of the laser chamber 10 through the windows 10a, 10b. The beam width in the H-axis direction of the light output through the window 10a of the laser chamber 10 is expanded by the prism 14a, and then the light is incident on the grating 14b.

The light incident on the grating 14b from the prism 14a is reflected by a plurality of grooves of the grating 14b and is diffracted in a direction corresponding to a wavelength of the light.

The prism 14a reduces the beam width, in the H-axis direction, of the diffracted light from the grating 14b and returns the light to the laser chamber 10 through the window 10a.

The output coupling mirror 15 transmits and outputs a part of the light output from the window 10b of the laser chamber 10, and reflects the other part back into the laser chamber 10.

In this way, the light output from the laser chamber 10 reciprocates between the line narrowing module 14 and the output coupling mirror 15, and is amplified each time the light passes through the discharge space between the cathode 11a the anode 11b. The light is line narrowed each time being turned back in the line narrowing module 14. Thus, the light having undergone laser oscillation and line narrowing is output as laser light from the output coupling mirror 15.

### 1.3 Problem of Comparative Example

FIG. 4 is a sectional view of the anode 11b used over a long period of time. When the anode 11b is used over a long period of time, the electrode base member 111 may deteriorate from the vicinity of the first discharge surface DS1. For example, a part of the electrode base member 111 may react with fluorine contained in the laser gas and become embrittled. A portion of the coating layer 112, in particular, coating the side surface SS1 is required to have a function of reinforcing an embrittled portion 111a of the electrode base member 111 and maintaining the intensity of the anode 11b.

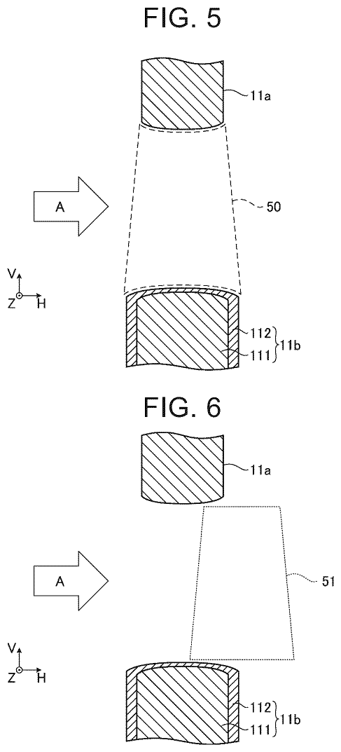

FIG. 5 schematically shows a state of discharge between the cathode 11a and the anode 11b in the comparative example. A discharge space 50 is formed between the cathode 11a and the anode 11b.

The coating layer 112 includes an insulating material for suppressing deterioration of the surface of the electrode base member 111, and the resistivity of the material configuring the coating layer 112 is higher than the resistivity of the material configuring the electrode base member 111. However, if the electrical resistance of the coating layer 112 is too high, discharge is less likely to occur, and therefore, the coating layer 112 includes a metal in addition to the insulating material. In addition, when a high voltage is applied between the cathode 11a and the anode 11b, an electric field is more likely to concentrate in the vicinity of a corner portion of the anode 11b. Therefore, the discharge space 50 also extends to the vicinity of the corner portion of the coating layer 112.

FIG. 6 schematically shows a state after discharge between the cathode 11a and the anode 11b shown in FIG. 5 is performed. Since the laser gas circulates inside the laser chamber 10 in the direction indicated by arrow A by the cross flow fan 21 (see FIG. 2), a discharge product 51 containing ions or fine metal particles generated by the discharge moves to a position in the +H direction when viewed from the discharge space 50 of FIG. 5.

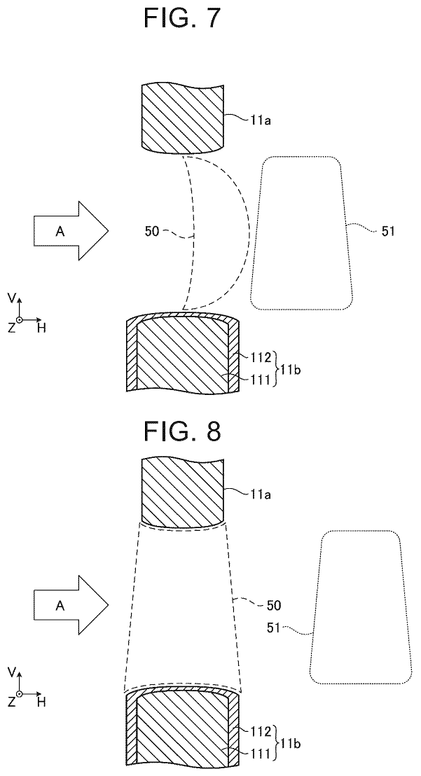

FIGS. 7 and 8 each schematically show a state of discharge subsequent to the discharge between the cathode 11a and the anode 11b shown in FIG. 5. In FIG. 7, the discharge product 51 is located close to the cathode 11a and the anode 11b, and in FIG. 8, the discharge product 51 is located far from the cathode 11a and the anode 11b.

In FIG. 7, the flow of electrons from the cathode 11a to the anode 11b by the discharge is attracted to the discharge product 51. Therefore, the discharge space 50 in FIG. 7 is formed to be biased in the +H direction, the discharge becomes unstable, and generation of the laser light becomes unstable.

On the other hand, as shown in FIG. 8, when the discharge product 51 is located far from the cathode 11a and the anode 11b, the discharge space 50 is formed in the same manner as the discharge space 50 in FIG. 5 without being significantly affected by the discharge product 51.

In order to increase the distance from the cathode 11a and the anode 11b to the discharge product 51 without reducing the repetition frequency of the laser light, the following methods (1) and (2) are available.
(1) To increase a flow velocity of the laser gas due to the cross flow fan 21
(2) To reduce a width of the discharge space 50 in the H-axis direction

However, if the flow velocity of the laser gas is increased, power consumption for driving the motor 22 may increase. The power consumption is proportional to the cube of the laser gas flow velocity.

Further, it is conceivable to narrow the width of the electrode base member 111 in order to reduce the width of the discharge space 50 in the H-axis direction. However, if the width of the electrode base member 111 is narrowed, deterioration may proceed to the center of the electrode base member 111 at an early stage, and the lifetime may be shortened.

Therefore, in order to reduce the width of the discharge space 50 in the H-axis direction, it is desirable to minimize the thickness T0 of the coating layer 112 at the portion coating the side surface SS1 (see FIG. 4).

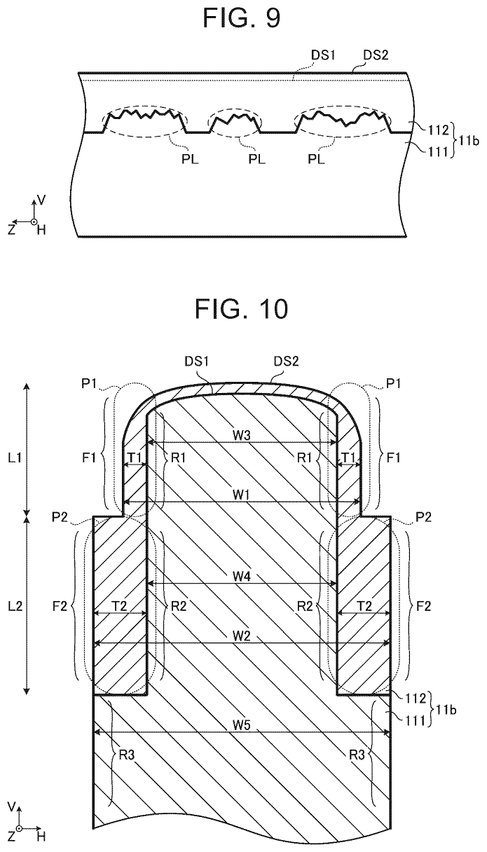

FIG. 9 shows the side surface of the anode 11b when the thickness T0 of the portion of the coating layer 112 coating the side surface SS1 is reduced. When the thickness T0 is 0.1 mm, there was a case in which peeling PL occurred at a part of the coating layer 112 during manufacturing of the anode 11b. Since the peeling PL of the coating layer 112 occurs at a portion far from the second discharge surface DS2, discharge itself is not significantly affected. However, deterioration of the electrode base member 111 exposed by the peeling PL may be accelerated.

Some embodiments described below relate to suppressing the peeling PL of the coating layer 112 while suppressing an increase in the width of the discharge space 50 in the H-axis direction and a decrease in the width of the electrode base member 111.

### 2. Anode 11b Having Step at Coating Layer 112

### 2.1 Configuration

FIG. 10 is a sectional view of the anode 11b configuring the discharge electrode according to a first embodiment. FIG. 10 shows a cross section perpendicular to the Z axis of the electrode base member 111 and the coating layer 112 configuring the anode 11b. The cathode 11a, which is not shown in FIG. 10, is located in the +V direction when viewed from the anode 11b. The cathode 11a is similar to that described with reference to FIG. 3.

Each of two side surfaces, parallel to the longitudinal direction, of the electrode base member 111 includes first, second, and third regions R1, R2, R3. The first, second, and third regions R1, R2, R3 are located in this order from the side closer to the cathode 11a. The first and second regions R1, R2 are coated with first and second portions P1, P2 of the coating layer 112, respectively.

The thickness T2 of the second portion P2 is larger than the thickness T1 of the first portion P1. For example, the thickness T1 is equal to or larger than 0.1 mm and equal to or smaller than 0.2 mm, and the thickness T2 is equal to or smaller than 0.5 mm as being larger than the thickness T1 by 0.05 mm or more.

At least a part of a surface F1 of the first portion P1 and at least a part of a side surface of a first region R1 of the electrode base member 111 are parallel to each other, and at least a part of a surface F2 of a second portion P2 and at least a part of a side surface of a second region R2 of the electrode base member 111 are parallel to each other.

Dimensions of the respective parts of the anode 11b are represented as follows.
W1: First width of the anode 11b including the first portions P1
W2: Second width of the anode 11b including the second portions P2
W3: Third width between the first regions R1
W4: Fourth width between the second regions R2
W5: Fifth width between the third regions R3

As shown in FIG. 10, the first and second regions R1, R2 are continuously flush. A step is formed between the surface F1 of the first portion P1 and the surface F2 of the second portion P2, and the second width W2 is larger than the first width W1. The step between the surfaces F1 and F2 does not affect the discharge if a length L1 of the first portion P1 is sufficient in the discharge direction, and the discharge width is determined by the first width W1.

Here, the first and second regions R1, R2 are not limited to being continuously flush, and it is only required that the difference between the third width W3 and the fourth width W4 is smaller than the difference between the first width W1 and the second width W2.

A step is formed between the second and third regions R2, R3, and the fifth width W5 is larger than the fourth width W4. The surface F2 of the second portion P2 and the third region R3 are continuously flush.

Here, the surface F2 and the third region R3 are not limited to being continuously flush, and it is only required that the difference between the fifth width W5 and the second width W2 is smaller than the difference between the first width W1 and the second width W2.

It is desirable that a length L2 of the second portion P2 in the discharge direction is larger than the length L1 of the first portion P1 in the discharge direction. The length L1 of the first portion P1 in the discharge direction is equal to or larger than 1.5 mm and is, for example, 2.0 mm. The length L2 of the second portion P2 in the discharge direction is equal to or larger than 3.0 mm and is, for example, 4.0 mm.

### 2.2 Effect

(1) The discharge electrodes according to the first embodiment are discharge electrodes to be used in the gas laser device 1 for exciting a laser gas containing fluorine by discharge, and include the cathode 11a and the anode 11b. The anode 11b is arranged as facing the cathode 11a and includes the electrode base member 111 including a metal, and the coating layer 112 including an insulating material and coating a part of the side surface, parallel to the longitudinal direction, of the electrode base member 111. The coating layer 112 includes the first portion P1 coating the first region R1 of the side surface of the electrode base member 111, and the second portion P2 coating the second region R2 of the side surface of the electrode base member 111, located farther from the cathode 11a than the first region R1 in the discharge direction perpendicular to the longitudinal direction, and being thicker than the first portion P1.

Accordingly, the discharge width is suppressed from increasing by suppressing the thickness of the first portion P1 of the coating layer 112 while sufficiently securing the width of the electrode base member 111 in order to suppress the deterioration of the electrode base member 111, and peeling can be suppressed by thickening the second portion P2 of the coating layer 112.

(2) In the first embodiment, at least a part of the surface F1 of the first portion P1 of the coating layer 112 and at least a part of the first region R1 of the side surface of the electrode base member 111 are parallel to each other.

Accordingly, the first portion P1 of the coating layer 112 can be processed with high dimensional accuracy, for example, by thermal spraying and polishing.

(3) In the first embodiment, at least a part of the surface F2 of the second portion P2 of the coating layer 112 and at least a part of the second region R2 of the side surface of the electrode base member 111 are parallel to each other.

Accordingly, the second portion P2 of the coating layer 112 can be processed with high dimensional accuracy, for example, by thermal spraying and polishing.

(4) In the first embodiment, the first and second regions R1, R2 and the first and second portions P1, P2 are located on each of two side surfaces, parallel to the longitudinal direction, of the electrode base member 111. The difference between the third width W3 between the first regions R1 and the fourth width W4 between the second regions R2 is smaller than the difference between the first width W1 of the anode 11b including the first portions P1 and the second width W2 of the anode 11b including the second portions P2.

Accordingly, since the difference between the third width W3 and the fourth width W4 is small, processing of the electrode base member 111 can be facilitated, and the thicknesses T1, T2 of the first and second portions P1, P2 can be adjusted by adjusting the difference between the first width W1 and the second width W2.

(5) In the first embodiment, the side surface of the electrode base member 111 includes the third region R3 located farther from the cathode 11a than the second region R2 in the discharge direction, and the first to third regions R1 to R3 and the first and second portions P1, P2 are located on each of two side surfaces, parallel to the longitudinal direction, of the electrode base member 111. The difference between the fifth width W5 between the third regions R3 and the second width W2 is smaller than the difference between the first width W1 of the anode 11b including the first portions P1 and the second width W2 of the anode 11b including the second portions P2.

Accordingly, since the difference between the fifth width W5 and the second width W2 is small, the second portion P2 can be processed with high dimensional accuracy having the third region R3 as a reference.

(6) In the first embodiment, the first region R1 and the second region R2 of the side surface of the electrode base member 111 are continuously flush, and a step is formed between the surface F1 of the first portion P1 of the coating layer 112 and the surface F2 of the second portion P2.

Accordingly, since the first region R1 and the second region R2 are continuously flush, processing of the electrode base member 111 can be facilitated, and the thicknesses T1, T2 of the first and second portions P1, P2 can be adjusted by adjusting the step between the surface F1 of the first portion P1 and the surface F2 of the second portion P2.

(7) In the first embodiment, the side surface of the electrode base member 111 includes the third region R3 located farther from the cathode 11a than the second region R2 in the discharge direction, and the surface F2 of the second portion P2 of the coating layer 112 and the third region R3 of the side surface of the electrode base member 111 are continuously flush.

Accordingly, since the surface F2 of the second portion P2 and the third region R3 are continuously flush, the second portion P2 can be processed with higher dimensional accuracy having the third region R3 as a reference.

(8) In the first embodiment, the thickness T1 of the first portion P1 in the direction perpendicular to the side surface of the electrode base member 111 is equal to or larger than 0.1 mm and equal to or smaller than 0.2 mm, and the thickness T2 of the second portion P2 in the direction perpendicular to the side surface of the electrode base member 111 is equal to or smaller than 0.5 mm as being thicker than the first portion P1 by 0.05 mm or more.

Accordingly, the discharge width can be suppressed from being increased while ensuring the thickness T1 of the first portion P1 sufficient for reinforcing the electrode base member 111. Further, it is possible to prevent processing of the second portion P2 from becoming difficult while ensuring the thickness T2 sufficient for suppressing peeling of the second portion P2 at the time of manufacturing.

(9) In the first embodiment, the length L2 of the second portion P2 in the discharge direction is larger than the length L1 of the first portion P1 in the discharge direction.

Accordingly, peeling of the second portion P2 can be sufficiently suppressed.

In other respects, the first embodiment is similar to the comparative example.

### 3. Anode 11b Having Step at Electrode Base Member 111

### 3.1 Configuration

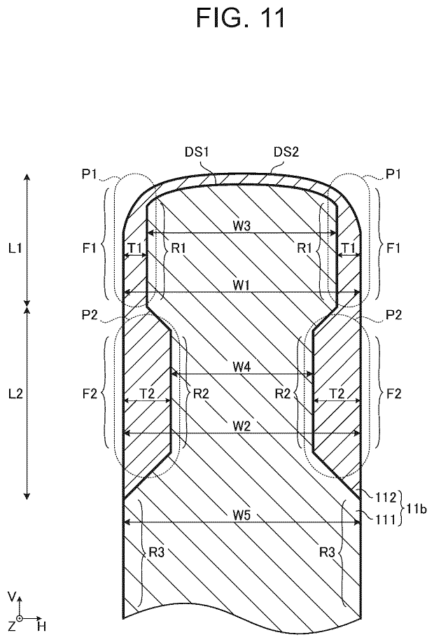

FIG. 11 is a sectional view of the anode 11b configuring the discharge electrode according to a second embodiment. FIG. 11 shows a cross section perpendicular to the Z axis of the electrode base member 111 and the coating layer 112 configuring the anode 11b. The cathode 11a, which is not shown in FIG. 11, is located in the +V direction when viewed from the anode 11b.

As shown in FIG. 11, a step is formed between the first and second regions R1, R2, a step is formed between the second and third regions R2, R3, the third width W3 is larger than the fourth width W4, and the fifth width W5 is larger than the third width W3. The surface F1 of the first portion P1 and the surface F2 of the second portion P2 are continuously flush, and the surface F2 of the second portion P2 and the third region R3 are continuously flush.

Here, the surfaces F1, F2 are not limited to being continuously flush, and it is only required that the difference between the first width W1 and the second width W2 is smaller than the difference between the third width W3 and the fourth width W4. Further, the surface F2 and the third region R3 are not limited to being continuously flush, and it is only required that the difference between the fifth width W5 and the second width W2 is smaller than the difference between the third width W3 and the fourth width W4.

### 3.2 Effect

(10) In the second embodiment, the first and second regions R1, R2 and the first and second portions P1, P2 are located on each of two side surfaces, parallel to the longitudinal direction, of the electrode base member 111. The difference between the first width W1 of the anode 11b including the first portions P1 and the second width W2 of the anode 11b including the second portions P2 is smaller than the difference between the third width W3 between the first regions R1 and the fourth width W4 between the second regions R2.

Accordingly, the first and second portions P1, P2 of the coating layer 112 can be processed with high dimensional accuracy by reducing the difference between the first width W1 and the second width W2. Further, it is possible to suppress the shape of the components arranged around the anode 11b from being complicated.

(11) In the second embodiment, the side surface of the electrode base member 111 includes the third region R3 located farther from the cathode 11a than the second region R2 in the discharge direction, and the first to third regions R1 to R3 and the first and second portions P1, P2 are located on each of two side surfaces, parallel to the longitudinal direction, of the electrode base member 111. The difference between the fifth width W5 between the third regions R3 and the second width W2 of the anode 11b including the second portion P2 is smaller than the difference between the third width W3 between the first regions R1 and the fourth width W4 between the second regions R2.

Accordingly, since the difference between the fifth width W5 and the second width W2 is small, the second portion P2 can be processed with high dimensional accuracy having the third region R3 as a reference.

(12) In the second embodiment, the third width W3 between the first regions R1 is larger than the fourth width W4 between the second regions R2.

Accordingly, it becomes easy to process the second portion P2 coating the second region R2 to be thicker than the first portion P1 coating the first region R1.

(13) In the second embodiment, the surface F1 of the first portion P1 of the coating layer 112 and the surface F2 of the second portion P2 are continuously flush.

Accordingly, the first and second portions P1, P2 can be processed with high dimensional accuracy. Further, it is possible to suppress the shape of the components arranged around the anode 11b from being complicated.

(14) In the second embodiment, the side surface of the electrode base member 111 includes the third region R3 located farther from the cathode 11a than the second region R2 in the discharge direction, the third width W3 between the first regions R1 is larger than the fourth width W4 between the second regions R2, and the fifth width W5 between the third regions R3 is larger than the third width W3.

Accordingly, it becomes easy to process the second portion P2 coating the second region R2 to be thicker than the first portion P1 coating the first region R1 by processing the first and second portions P1, P2 having the third region R3 as a reference.

(15) In the second embodiment, the side surface of the electrode base member 111 includes the third region R3 located farther from the cathode 11a than the second region R2 in the discharge direction, and the surface F2 of the second portion P2 of the coating layer 112 and the third region R3 of the side surface of the electrode base member 111 are continuously flush.

Accordingly, the surface F2 of the second portion P2 and the third region R3 are continuously flush, and thereby the second portion P2 can be processed with higher dimensional accuracy having the third region R3 as a reference.

In other respects, the second embodiment is similar to the first embodiment.

### 4. Manufacturing Method of Anode 11b Having Step at Coating Layer 112

### 4.1 Manufacturing Process

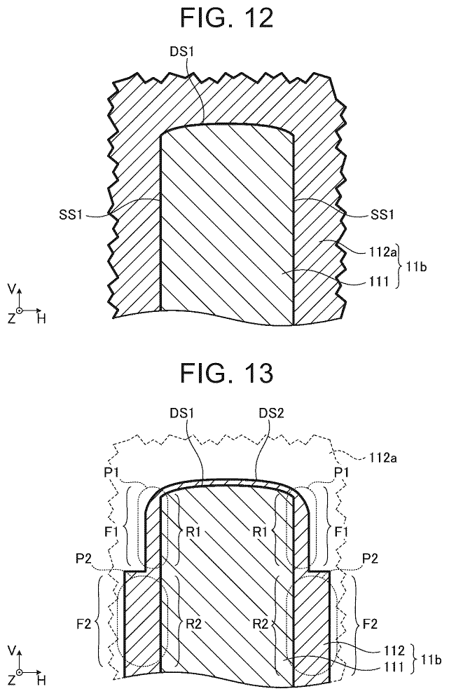

FIGS. 12 and 13 are sectional views showing a manufacturing process of the anode 11b configuring the discharge electrode according to the third embodiment. FIGS. 12 and 13 show cross sections perpendicular to the Z axis of the electrode base member 111 and the coating layer 112, 112a configuring the anode 11b. The cathode 11a, which is not shown in FIGS. 12 and 13, is arranged in the +V direction when viewed from the anode 11b. In FIGS. 12 and 13, irregularities on the surface of the coating layer 112a are exaggerated.

The manufacturing method of the anode 11b is as follows. As shown in FIG. 12, the coating layer 112a is formed on the side surface SS1, to parallel the longitudinal direction, of the electrode base member 111 configuring the anode 11b and the first discharge surface DS1 to be a surface facing the cathode 11a. The coating layer 112a is formed, for example, by thermal spraying. The thermal sprayed film is formed to have a substantially uniform thickness along the outer shape of the electrode base member 111. The process of forming the coating layer 112a corresponds to the first process in the present disclosure.

As shown in FIG. 13, a part of the coating layer 112a is removed to provide a shape close to a target shape, for example, by grinding or polishing the coating layer 112a. At this time, a part of the coating layer 112a is removed such that the second portion P2 coating the second region R2 of the side surface SS1 is thicker than the first portion P1 coating the first region R1 of the side surface SS1. Accordingly, a step is formed between the surface F1 of the first portion P1 and the surface F2 of the second portion P2. Further, the second discharge surface DS2 is formed. The process of removing a part of the coating layer 112a corresponds to the second process in the present disclosure.

Thus, the coating layer 112 having the shape described in the first embodiment is formed.

### 4.2 Effect

(16) The manufacturing method according to the third embodiment is a method of manufacturing the anode 11b as a discharge electrode to be used as facing the cathode 11a in the gas laser device 1 for exciting a laser gas containing fluorine by discharge, the method including the first process of forming the coating layer 112a on the side surface, parallel to the longitudinal direction, of the electrode base member 111 configuring the anode 11b, and the second process of removing a part of the coating layer 112a so as to provide a shape close to the target shape. The second process includes removing a part of the coating layer 112a such that the second portion P2 coating the second region R2 of the side surface of the electrode base member 111, located farther from the cathode 11a than the first region R1 of the side surface of the electrode base member 111 in the discharge direction perpendicular to the longitudinal direction, is thicker than the first portion P1 coating the first region R.

Accordingly, the coating layer 112 can be processed with high dimensional accuracy, the discharge width is suppressed from increasing by suppressing the thickness of the first portion P1 of the coating layer 112 while sufficiently securing the width of the electrode base member 111 in order to suppress the deterioration of the electrode base member 111, and peeling during manufacturing can be suppressed by thickening the second portion P2 of the coating layer 112.

(17) In the third embodiment, the second process includes forming a step between the surface F1 of the first portion P1 of the coating layer 112 and the surface F2 of the second portion P2.

Accordingly, the thicknesses of the first and second portions P1, P2 can be adjusted by adjusting the step between the surface F1 of the first portion P1 and the surface F2 of the second portion P2.

In other respects, the third embodiment is similar to the first embodiment.

### 5. Manufacturing Method of Anode 11b Having Step at Electrode Base Member 111

### 5.1 Manufacturing Process

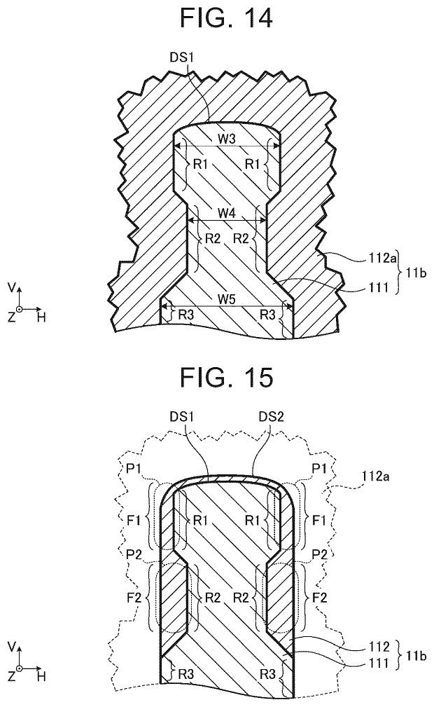

FIGS. 14 and 15 are sectional views showing a manufacturing process of the anode 11b configuring the discharge electrode according to a fourth embodiment. FIGS. 14 and 15 show cross sections perpendicular to the Z axis of the electrode base member 111 and the coating layer 112, 112a configuring the anode 11b. The cathode 11a, which is not shown in FIGS. 14 and 15, is arranged in the +V direction when viewed from the anode 11b. In FIGS. 14 and 15, irregularities on the surface of the coating layer 112a are exaggerated.

The manufacturing method of the anode 11b is as follows. As shown in FIG. 14, the electrode base member 111 is processed such that the fourth width W4 between the second regions R2 is smaller than the third width W3 between the first regions R1 of the electrode base member 111 configuring the anode 11b. The process of processing the electrode base member 111 corresponds to the third process in the present disclosure. Next, the coating layer 112a is formed on the first to third regions R1 to R3 of the side surface of the electrode base member 111 and the first discharge surface DS1 to be a surface facing the cathode 11a. The coating layer 112a is formed, for example, by thermal spraying. The thermal sprayed film is formed to have a substantially uniform thickness along the outer shape of the electrode base member 111. The process of forming the coating layer 112a corresponds to the first process in the present disclosure.

As shown in FIG. 15, a part of the coating layer 112a is removed to provide a shape close to a target shape, for example, by grinding or polishing the coating layer 112a. Accordingly, the step between the surface F1 of the first portion P1 and the surface F2 of the second portion P2 is reduced. Further, the second discharge surface DS2 is formed. The process of removing a part of the coating layer 112a corresponds to the second process in the present disclosure.

Thus, the coating layer 112 having the shape described in the second embodiment is formed.

### 5.2 Effect

(18) In the fourth embodiment, the first and second regions R1, R2 are located on each of two side surfaces, parallel to the longitudinal direction, of the electrode base member 111. The manufacturing method of the anode 11b includes the third process of processing the electrode base member 111 such that the fourth width W4 between the second regions R2 is smaller than the third width W3 between the first regions R1 before the first process.

Accordingly, it becomes easy to process the second portion P2 coating the second region R2 to be thicker than the first portion P1 coating the first region R1.

(19) In the fourth embodiment, the second process includes reducing the step between the surface F1 of the first portion P1 of the coating layer 112 and the surface F2 of the second portion P2.

Accordingly, the first and second portions P1, P2 can be processed with high dimensional accuracy.

In other respects, the fourth embodiment is similar to the second embodiment.

### 6. Others

FIG. 16 schematically shows the configuration of the exposure apparatus 100 connected to the gas laser device 1. The gas laser device 1 generates laser light and outputs the laser light to the exposure apparatus 100. In FIG. 16, the exposure apparatus 100 includes an illumination optical system 40 and a projection optical system 41. The illumination optical system 40 illuminates a reticle pattern of a reticle (not shown) arranged on a reticle stage RT with laser light incident from the gas laser device 1. The projection optical system 41 causes the laser light transmitted through the reticle to be imaged as being reduced and projected on a workpiece (not shown) arranged on a workpiece table WT. The workpiece is a photosensitive substrate such as a semiconductor wafer on which photoresist is applied. The exposure apparatus 100 synchronously translates the reticle stage RT and the workpiece table WT to expose the workpiece to the laser light reflecting the reticle pattern. After the reticle pattern is transferred onto the semiconductor wafer by the exposure process described above, an electronic device can be manufactured through a plurality of processes.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. Discharge electrodes to be used in a gas laser device for exciting a laser gas containing fluorine by discharge, comprising:
a cathode; and
an anode,
the anode being arranged as facing the cathode and including an electrode base member including a metal, and a coating layer including an insulating material and coating a part of a side surface, parallel to a longitudinal direction, of the electrode base member, and
the coating layer including a first portion coating a first region of the side surface and a second portion coating a second region of the side surface, located farther from the cathode than the first region in a discharge direction perpendicular to the longitudinal direction, and being thicker than the first portion.

2. The discharge electrodes according to claim 1,
wherein at least a part of a surface of the first portion of the coating layer and at least a part of the first region of the side surface are parallel to each other.

3. The discharge electrodes according to claim 1,
wherein at least a part of a surface of the second portion of the coating layer and at least a part of the second region of the side surface are parallel to each other.

4. The discharge electrodes according to claim 1,
wherein the first and second regions and the first and second portions are located on each of two side surfaces, parallel to the longitudinal direction, including the side surface, and
a difference between a third width between the first regions and a fourth width between the second regions is smaller than a difference between a first width of the anode including the first portions and a second width of the anode including the second portions.

5. The discharge electrodes according to claim 1,
wherein the side surface includes a third region located farther from the cathode than the second region in the discharge direction,
the first to third regions and the first and second portions are located on each of two side surfaces, parallel to the longitudinal direction, including the side surface, and
a difference between a fifth width between the third regions and a second width of the anode including the second portions is smaller than a difference between a first width of the anode including the first portions and the second width.

6. The discharge electrodes according to claim 1,
wherein the first region and the second region of the side surface are continuously flush, and
a step is formed between a surface of the first portion and a surface of the second portion of the coating layer.

7. The discharge electrodes according to claim 6,
wherein the side surface includes a third region located farther from the cathode than the second region in the discharge direction, and
the surface of the second portion of the coating layer and the third region of the side surface are continuously flush.

8. The discharge electrodes according to claim 1,
wherein a thickness of the first portion in a direction perpendicular to the side surface is equal to or larger than 0.1 mm and equal to or smaller than 0.2 mm, and
a thickness of the second portion in the direction perpendicular to the side surface is equal to or smaller than 0.5 mm as being thicker than the first portion by 0.05 mm or more.

9. The discharge electrodes according to claim 1,
wherein a length of the second portion in the discharge direction is larger than a length of the first portion in the discharge direction.

10. The discharge electrodes according to claim 1,
wherein the first and second regions and the first and second portions are located on each of two side surfaces, parallel to the longitudinal direction, including the side surface, and
a difference between a first width of the anode including the first portions and a second width of the anode including the second portions is smaller than a difference between a third width between the first regions and a fourth width between the second regions.

11. The discharge electrodes according to claim 1,
wherein the side surface includes a third region located farther from the cathode than the second region in the discharge direction,
the first to third regions and the first and second portions are located on each of two side surfaces, parallel to the longitudinal direction, including the side surface, and
a difference between a fifth width between the third regions and a second width of the anode including the second portions is smaller than a difference between a third width between the first regions and a fourth width between the second regions.

12. The discharge electrodes according to claim 1,
wherein a third width between the first regions is larger than a fourth width between the second regions.

13. The discharge electrodes according to claim 12,
wherein a surface of the first portion and a surface of the second portion of the coating layer are continuously flush.

14. The discharge electrodes according to claim 12,
wherein the side surface includes a third region located farther from the cathode than the second region in the discharge direction, and
a fifth width between the third regions is larger than the third width.

15. The discharge electrodes according to claim 12,
wherein the side surface includes a third region located farther from the cathode than the second region in the discharge direction, and
a surface of the second portion of the coating layer and the third region of the side surface are continuously flush.

16. A manufacturing method of an anode of discharge electrodes to be used in a gas laser device for exciting a laser gas containing fluorine by discharge in arrangement as facing a cathode, comprising:
a first process of forming a coating layer on a side surface, parallel to a longitudinal direction, of an electrode base member configuring the anode, and
a second process of removing a part of the coating layer to provide a shape close to a target shape,
the second process including removing a part of the coating layer such that a second portion coating a second region of the side surface, located farther from the cathode than a first region of the side surface in a discharge direction perpendicular to the longitudinal direction, is thicker than a first portion coating the first region.

17. The manufacturing method according to claim 16,
wherein the second process includes forming a step between a surface of the first portion and a surface of the second portion of the coating layer.

18. The manufacturing method according to claim 16,
wherein the first and second regions are located on each of two side surfaces, parallel to the longitudinal direction, including the side surface, and
the manufacturing method further includes, before the first process, a third process of processing the electrode base member such that a fourth width between the second regions is smaller than a third width between the first regions.

19. The manufacturing method according to claim 18,
wherein the second process includes reducing a step between a surface of the first portion and a surface of the second portion of the coating layer.

20. An electronic device manufacturing method, comprising:
generating laser light using a gas laser device including a laser chamber including discharge electrodes;
outputting the laser light to an exposure apparatus; and
exposing a photosensitive substrate to the laser light in the exposure apparatus to manufacture an electronic device,
the discharge electrodes being discharge electrodes to be used in the gas laser device for exciting a laser gas containing fluorine by discharge, and including a cathode and an anode,
the anode being arranged as facing the cathode and including an electrode base member including a metal, and a coating layer including an insulating material and coating a part of a side surface, parallel to a longitudinal direction, of the electrode base member, and
the coating layer including a first portion coating a first region of the side surface and a second portion coating a second region of the side surface, located farther from the cathode than the first region in a discharge direction perpendicular to the longitudinal direction, and being thicker than the first portion.
